(19) United States
(12) Patent Application Publication
(10) Pub. No.: US 2020/0175534 A1
(43) Pub. Date: Jun. 4, 2020

(54) METHODS, SYSTEMS, AND MEDIA FOR ENERGY MANAGEMENT

(71) Applicant: Sidewalk Labs LLC, New York, NY (US)

(72) Inventors: Rohit Thomas Aggarwala, New York, NY (US); Charlotte Matthews, New York, NY (US); Jeff Tarr, New York, NY (US); Rachel Steinberg, New York, NY (US); Emily Kildow, New York, NY (US)

(21) Appl. No.: 16/703,661

(22) Filed: Dec. 4, 2019

Related U.S. Application Data
(60) Provisional application No. 62/775,360, filed on Dec. 4, 2018.

(51) Int. Cl. G06Q 30/02; G06Q 10/06; G05B 13/04; G06F 1/3206; G01W 1/02

(52) U.S. Cl. CPC G06Q 30/0206; G06Q 10/06315; G05B 13/041; G06Q 50/06; G06F 1/3206; G01W 1/02; G05B 13/047

(57) ABSTRACT

Methods, systems, and media for energy management are provided. In some embodiments, the method comprises: identifying a plurality of devices associated with a building; generating a standardized identifier for each of the plurality of devices, wherein the standardized identifier includes location information, a device type, and an index number; receiving weather data and energy pricing information; receiving, from the plurality of devices, a stream of building data, wherein each piece of building data has a data type and is associated with the standardized identifier for that device; determining whether operation of one or more of the plurality devices is to be modified based on the weather data, the energy pricing information, and the stream of building data; in response to determining that the operation of a device is to be modified based on the weather data, the energy pricing information, and the stream of building data, determining operating instructions based on the device type and the location information from the standardized identifier of the device; and transmitting the operating instructions to the device associated with the building.

### CROSS-REFERENCE TO RELATED APPLICATIONS

This application claims the benefit of U.S. Provisional Patent Application No. 62/775,360, filed Dec. 4, 2018, which is hereby incorporated by reference herein in its entirety.

### TECHNICAL FIELD

The disclosed subject matter relates to methods, systems, and media for energy management.

### BACKGROUND

Buildings can waste substantial amounts of energy, particularly at times when a building is not in use. For example, an office building may not be occupied or in use at night or on weekends, but thermostats in the office may still be set such that the building is being heated or cooled even when not in use. As another example, lights (e.g., hall lights, conference room lights, lobby lights, etc.) may remain on at times when a building is not in use. Adjusting settings of lights, appliances, thermostats, etc. of a building may save energy. However, it can be difficult to determine how these devices should be adjusted. For example, existing building management systems typically struggle to coordinate and/or integrate every system in a building, where one system may control lighting and another system may control heating and cooling, thereby making it difficult to use data to improve efficiencies across both systems.

Accordingly, it is desirable to provide new methods, systems, and media for energy management.

### SUMMARY

Methods, systems, and media for energy management are provided.

In accordance with some embodiments of the disclosed subject matter, a method for energy management is provided, the method comprising: identifying a plurality of devices associated with a building; generating a standardized identifier for each of the plurality of devices, wherein the standardized identifier includes location information, a device type, and an index number; receiving weather data and energy pricing information; receiving, from the plurality of devices, a stream of building data, wherein each piece of building data has a data type and is associated with the standardized identifier for that device; determining whether operation of one or more of the plurality devices is to be modified based on the weather data, the energy pricing information, and the stream of building data; in response to determining that the operation of a device is to be modified based on the weather data, the energy pricing information, and the stream of building data, determining operating instructions based on the device type and the location information from the standardized identifier of the device; and transmitting the operating instructions to the device associated with the building.

In some embodiments, the plurality of devices includes one or more of: a lighting sensor, a solar radiation sensor, an occupancy sensor, a temperature sensor, an air quality sensor, a smoke detector, a ventilation system, a heating system, a cooling system, an access control system, a media device, a thermostat device, a window shade device, an electrochromic glass device, a lighting system, a home appliance, and a smart power outlet.

In some embodiments, the method further comprises: determining a user-selected energy usage criterion; and, based on the user-selected energy usage criterion, causing a user interface to be presented on a computing device that requests a user initiate the modification of the operation of the device with the determined operating instructions.

In some embodiments, the modification of the operation of the device is determined using an optimizer that receives the weather data, the energy pricing information, and the stream of building data as input.

In some embodiments, a second portion of building data is derived from a first portion building data in the stream of building data.

In some embodiments, the method further comprises: determining that the device associated with the building is not capable of being controlled via the transmitted operation instructions; and causing a user interface to be presented that suggests an adjustment in the operation of the device using the operation instructions.

In accordance with some embodiments of the disclosed subject matter, a system for energy management is provided, the system comprising a hardware processor that is configured to: identify a plurality of devices associated with a building; generate a standardized identifier for each of the plurality of devices, wherein the standardized identifier includes location information, a device type, and an index number; receive weather data and energy pricing information; receive, from the plurality of devices, a stream of building data, wherein each piece of building data has a data type and is associated with the standardized identifier for that device; determine whether operation of one or more of the plurality devices is to be modified based on the weather data, the energy pricing information, and the stream of building data; in response to determining that the operation of a device is to be modified based on the weather data, the energy pricing information, and the stream of building data, determine operating instructions based on the device type and the location information from the standardized identifier of the device; and transmit the operating instructions to the device associated with the building.

In accordance with some embodiments of the disclosed subject matter, a non-transitory computer-readable medium containing computer executable instructions that, when executed by a processor, cause the processor to perform a method for energy management is provided, the method comprising: identifying a plurality of devices associated with a building; generating a standardized identifier for each of the plurality of devices, wherein the standardized identifier includes location information, a device type, and an index number; receiving weather data and energy pricing information; receiving, from the plurality of devices, a stream of building data, wherein each piece of building data has a data type and is associated with the standardized identifier for that device; determining whether operation of one or more of the plurality devices is to be modified based on the weather data, the energy pricing information, and the stream of building data; in response to determining that the operation of a device is to be modified based on the weather data, the energy pricing information, and the stream of building data, determining operating instructions based on the device type and the location information from the standardized identifier of the device; and transmitting the operating instructions to the device associated with the building.

In accordance with some embodiments of the disclosed subject matter, a system for energy management is provided, the system comprising: means for identifying a plurality of devices associated with a building; means for generating a standardized identifier for each of the plurality of devices, wherein the standardized identifier includes location information, a device type, and an index number; means for receiving weather data and energy pricing information; means for receiving, from the plurality of devices, a stream of building data, wherein each piece of building data has a data type and is associated with the standardized identifier for that device; means for determining whether operation of one or more of the plurality devices is to be modified based on the weather data, the energy pricing information, and the stream of building data; means for determining operating instructions based on the device type and the location information from the standardized identifier of the device in response to determining that the operation of a device is to be modified based on the weather data, the energy pricing information, and the stream of building data; and means for transmitting the operating instructions to the device associated with the building.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative example of a schematic diagram for energy management in accordance with some embodiments of the disclosed subject matter.

FIG. 2 shows an illustrative example of a process for energy management in accordance with some embodiments of the disclosed subject matter.

FIGS. 3A-3S show illustrative examples of user interfaces that can be presented by a scheduler application in managing energy consumption in accordance with some embodiments of the disclosed subject matter.

FIG. 4 shows a schematic diagram of an illustrative system suitable for implementation of mechanisms described herein for energy management in accordance with some embodiments of the disclosed subject matter.

FIG. 5 shows a detailed example of hardware that can be used in a server and/or a user device of FIG. 4 in accordance with some embodiments of the disclosed subject matter.

### DETAILED DESCRIPTION

In accordance with various embodiments, mechanisms (which can include methods, systems, and media) for energy management are provided.

Generally speaking, the mechanisms described herein can provide one or more automated schedulers for offices, homes, and building operators that schedule and/or manage systems, equipment, and appliances that impact energy use and greenhouse gas emissions. These schedulers can integrate building system data, incorporate external data sources (e.g., tenant temperature preferences, operating budgets, building occupancy, weather forecasts, and real-time energy prices), and determine equipment control and scheduling (e.g., consistent with energy cost goals). For example, these schedulers can automatically communicate equipment control instructions and/or scheduling instructions to building systems (e.g., to adjust temperatures or control lighting).

It should be noted that each automated scheduler can be associated with a particular scheduler type. For example, an automated scheduler can be an office scheduler that assists tenants with managing energy consumption and costs in an office building by optimizing building systems under tenant control, based on factors, such as weather and energy prices. In another example, an automated scheduler can be a home scheduler that assists a household to manage energy consumption in a home based on a budget for energy costs.

In some embodiments, the mechanisms described herein can be used to modify energy usage within buildings. For example, in some embodiments, the mechanisms can be used to control devices that contribute to energy usage within a building, such as thermostats, lights and light switches, window shades, and building equipment (e.g., fans, heat pumps, etc.) such that overall energy usage within the building can be reduced.

In some embodiments, the mechanisms described herein can control devices that contribute to energy usage in any suitable manner and based on any suitable information. For example, in some embodiments, the mechanisms can cause one or more thermostats of a building to be set to particular temperatures such that a heating system is less likely to be activated and/or an air-conditioning system is less likely to be activated at times of day when the building is unlikely to be occupied. As a more particular example, in an instance in which the building is determined to be unlikely to be occupied at night and/or on weekends (e.g., in the case of an office building), the mechanisms can cause a thermostat to be set at a higher temperature during summer months and/or at a lower temperature during winter months. As another example, in some embodiments, the mechanisms can cause lights of a building to be deactivated and/or turned off during times of day the building and/or days of the week the building is unlikely to be occupied. As yet another example, in some embodiments, the mechanisms can cause window treatments and/or window shades of windows of a building to be drawn and/or adjusted in transparency based on any suitable information, such as an amount of outdoor sunlight. As a more particular example, in an instance where the mechanisms determine that there is more than a predetermined amount of outdoor sunlight, the mechanisms can cause window shades to be opened and/or a transparency of window treatments to be increased, thereby allowing a room of the building corresponding to the windows to be naturally heated rather than using a heating system of the building to heat the building.

In some embodiments, the mechanisms described herein can receive data from any suitable devices or sensors within the building (e.g., thermometers and/or thermostats, lights, light sensors, motion sensors, and/or any other suitable devices or sensors) and/or any other suitable information (e.g., weather forecast information, calendar information, and/or any other suitable information) and can aggregate the received data in any suitable manner. For example, to prevent glare, help manage temperature, and control lights, shades, and/or electrochromic glass, the mechanisms described herein can receive data from one or more light and solar radiation sensors upon receiving content and/or authorization. In another example, to adjust convenience electronics or appliances having flexibility in run times (e.g., a dishwasher in a residential home, monitors in a business during night hours, etc.), the mechanisms described herein can receive data from one or more plug load monitors that are in select outlets and/or appliances. In yet another example, the mechanisms described herein can receive data from one or more sensors for smoke, temperature, and air quality (e.g., carbon dioxide, volatile organic compounds, humidity, carbon monoxide, etc.). In a further example, to determine when heating, cooling, convenience plug loads, and lighting changes can save energy, the mechanisms described herein can receive data from one or more occupancy sensors and/or integrations with access control systems. In some such embodiments, the mechanisms can analyze the received data to determine a manner in which devices that contribute to energy usage within the building (e.g., thermostats, lights, window shades, building equipment, etc.) are to be controlled and/or set to minimize energy usage. For example, in some embodiments, the mechanisms can receive any suitable data or information and can determine rules or parameters for thermostats, lights, etc. within a building that will reduce or minimize energy usage. As a more particular example, in some embodiments, the mechanisms can determine that a particular building is unlikely to be occupied on weekends and that lights of the building are therefore to be turned off on weekends, as described above. In some embodiments, the mechanisms can use any suitable algorithms to determine rules or parameters for devices that contribute to energy usage within a building.

Note that, in some embodiments, data collected can be aggregated and made available in any suitable manner. For example, in some embodiments, the data can be anonymized with respect to a building from which the data was collected and can be made available via any suitable Application Programming Interface (API) to any suitable third-party applications or developers.

It should be noted that these mechanisms can be used in any suitable application.

For example, a tenant can use an automated scheduler to set an energy budget and, based on the energy budget, actual and/or predicted occupancy information, weather information, energy pricing information, the automated scheduler can automate the operation of energy systems and devices, such as air conditioners, dishwashers, drying machines, etc. In continuing this example, a lower energy budget set by the tenant can results in a greater amount of automation of the operation of energy systems and devices in the home by the automated scheduler. Conversely, a higher energy budget set by the tenant can result in little or no intervention by the automated scheduler in which the tenant may be provided with the opportunity to override the automated operation of the energy systems and devices in the home by the automated scheduler.

In another example, a facilities manager can opt-in to optimized control of tenant-controlled systems and devices based upon the actual and/or predicted inputs of occupancy information, weather information, and energy pricing information. This can, for example, deliver predictable energy bills, reduce and/or eliminate energy waste, manage peak demand, and respond to tenant control requests.

In yet another example, a building operator can opt-in to optimized control of central building systems based upon the actual and predicted inputs of occupancy information, weather information, and energy pricing information. This can also, for example, deliver predictable energy bills, reduce and/or eliminate energy waste, manage peak demand, and respond to tenant control requests.

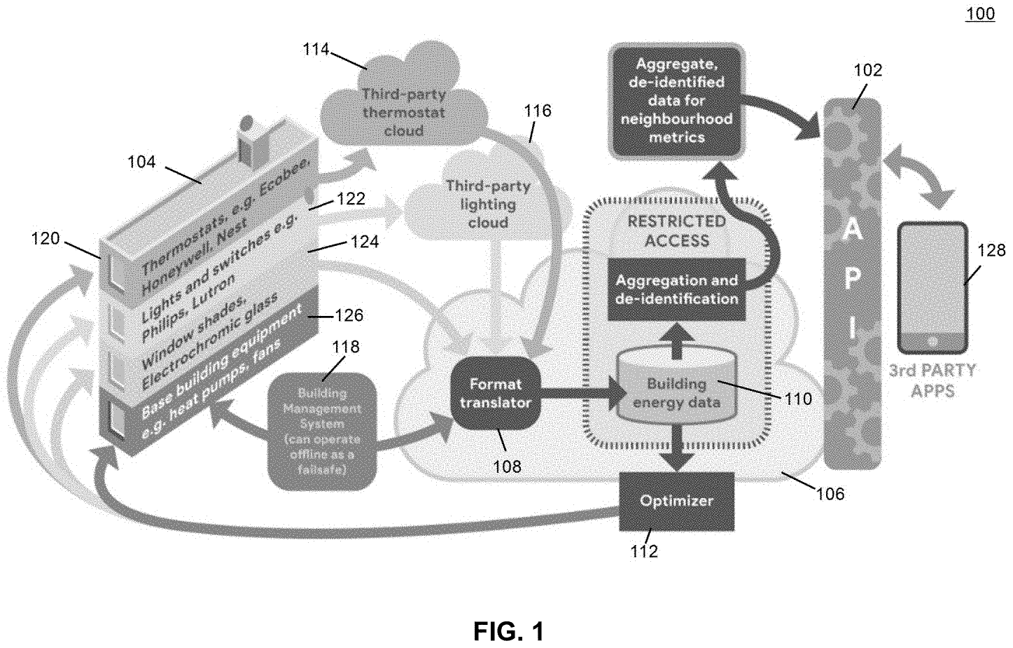

Turning to FIG. 1, an example 100 of a schematic diagram for energy management is shown in accordance with some embodiments of the disclosed subject matter. As illustrated, in some embodiments, diagram 100 can include an API 102, a building 104, and/or an energy management cloud 106.

In some embodiments, API 102 can be used to collect data related to energy use within building 104. For example, in some embodiments, API 102 can collect and/or aggregate data from energy management cloud 106 that relates to usage of thermostats 120 within building 104, usage of lights 122 within building 104, usage of window shades and window treatments 124 within building 104, and/or usage of building equipment 126 within building 104. As a more particular example, in some embodiments, API 102 can collect and/or aggregate data such as thermostat settings at different times of day and/or days of the week, times lights within building 104 are turned on and/or turned off, temperatures within different portions of building 104, an amount of outdoor sunlight around building 104 at different times of day, occupancy levels of building 104 at different times of day, and/or any other suitable data.

In some embodiments, API 102 can be used by any suitable third-party applications 128 for any suitable purpose. For example, in some embodiments, API 102 can be used by third-party applications 128 to access data relating to energy usage within building 104. Note that, in some embodiments, any data collected and/or aggregated by API 102 can be anonymized and/or de-identified in any suitable manner. For example, in some embodiments, data relating to energy usage within building 104 can be stored in association with a randomly generated identifier corresponding to building 104 rather than an address or name of building 104.

In some embodiments, building 104 can be any suitable type of building. For example, in some embodiments, building 104 can be an office building, a house, an apartment building, a school, and/or any other suitable building. In some embodiments, energy usage within building 104 can be controlled by any suitable devices, such as thermostats 122, lights 124, window shades and window treatments 124, and/or building equipment 126. In some embodiments, thermostats 122 can be any suitable smart thermostats (e.g., that automatically adjust temperature settings and/or any other suitable settings) that can be controlled by any suitable third-party thermostat cloud 114. In some embodiments, lights 124 can be any suitable smart lights and/or smart switches connected to lights (e.g., lights and/or switches that are automatically activated or deactivated based on a current lighting condition, a current time of day, user preferences, and/or in any other suitable manner) that can be controlled by any suitable third-party lighting cloud 116. In some embodiments, window shades and window treatments 124 can be any suitable window shades and/or electrochromic glass that can be adjusted based on, for example, a current outdoor lighting level. For example, in some embodiments, window shades and window treatments 124 can be automatically adjusted such that a tint of glass darkens in response to a determination that a current outdoor lighting level exceeds a predetermined lighting level, and/or in response to any other suitable determination. In some embodiments, building equipment 126 can include any suitable building equipment that, for example, controls a heat level within building 104, such as heat pumps, fans, and/or any other suitable building equipment that can be adjusted.

In some embodiments, energy management cloud 106 can be any suitable server or group of servers for collecting energy usage data from building 104 and/or adjusting settings of devices that contribute to energy usage within building 104. For example, in some embodiments, energy management cloud 106 can receive data relating to energy usage within building 104 and/or operation of devices that contribute to energy usage within building 104 (e.g., thermostats 120, lights 122, window shades and window treatments 124, building equipment 126, etc.) and can aggregate the received data. As a more particular example, in some embodiments, energy management cloud 106 can receive data that indicates preferred temperatures of different areas of building 104 at different times of day. As another example, in some embodiments, energy management cloud 106 can receive data that indicates measured or detected characteristics of building 104. As a more particular example, in some embodiments, energy management cloud 106 can receive data that indicates temperatures of different portions of building 104 at different times of day (e.g., due to heating from sunlight through windows, etc.). As another more particular example, in some embodiments, energy management cloud 106 can receive data that indicates characteristics relating to usage of building 104, such as occupancy of different areas of building 104 at different times of day, and/or any other suitable occupancy information.

Note that, in some embodiments, energy management cloud 106 can receive data from any other suitable sources, such as a calendar device or multiple calendar devices associated with building 104, weather forecasts, and/or any other suitable data. For example, in some embodiments, energy management cloud 106 can receive event data from a calendar device associated with building 104 that indicates dates and/or times building 104 is likely to be occupied and/or date and/or times portions of building 104 is likely to be occupied. As a more particular example, in some embodiments, the event data can indicate dates and/or times a conference room within building 104 is likely to be occupied. As another more particular example, in some embodiments, the even data can indicate dates and/or times an atypical evening event or an atypical weekend event is to be held at an office building. As another example, in some embodiments, energy management cloud 106 can receive information indicating a weather forecast for a geographic region in which building 104 is located that can indicate any suitable weather information, such as predicted temperatures, predicted storms, and/or any other suitable weather information.

In some embodiments, received data can be stored in any suitable manner, such as in energy database 110. Note that, in some embodiments, energy management cloud 106 can receive data through any suitable intermediary devices. For example, in some embodiments, energy management cloud 106 can receive data through a building management system 118. As a more particular example, in some embodiments, building management system 118 can receive data from any devices that contribute to energy usage within building 104 (e.g., devices 120-126), and can transmit the received data to energy management cloud 106. As another more particular example, in some embodiments, energy management cloud 106 can receive data through third-party thermostat cloud 114 (e.g., that indicates data associated with thermostats 120) and/or through third-party lighting cloud 116 (e.g., that indicates data associated with lights 122). Note that, in some embodiments, data received by energy management cloud 106 can be processed to be in any suitable format prior to storage in energy database 110. For example, in some embodiments, energy management cloud 106 can use a format translator 108 to convert data received from multiple sources (e.g., from building management system 118, from third-party thermostat cloud 114, from third-party lighting cloud 116, etc.) to a common format prior to storage in energy database 110.

In some embodiments, format translator 108 can convert identified devices and sensors that are associated with a building into a set of standardized identifiers. For example, a standardized identifier can include any suitable metadata in which devices are named by floor, room number, device type, and an index. In a more particular example, television devices can be identified as 19-301-TV-1, 19-302-TV-1, etc., while thermostat devices can be identified as 19-301-TSAT-1 and 19-302-TSAT-1. Such a naming schema can, for example, allow the energy management server described herein to determine which rooms of a building a television device is located and how to control the lighting devices and the thermostat devices in the room to prepare for an event (e.g., a presentation).

In some embodiments, energy management cloud 106 can use received data to control devices that contribute to energy usage within building 104. For example, in some embodiments, energy management cloud 106 can identify particular times of day and/or days of the week when building 104 is unlikely to be occupied and can adjust thermostats 120 and/or lights 122 based on the determination. As a more particular example, in some embodiments, energy management cloud 106 can adjust thermostats 120 to a temperature such that a heater is less likely to be activated and/or an air-conditioner is less likely to be activated at times of day that building 104 is unlikely to be occupied. As another more particular example, in some embodiments, energy management cloud 106 can set any of lights 122 to be off at times of day building 104 is unlikely to be occupied. As another example, in some embodiments, energy management cloud 106 can transmit instructions to window shades and/or window treatments 124 such that window shades are drawn and/or electrochromic glass is darkened in response to particular outdoor lighting conditions.

Note that, in some embodiments, energy management cloud 106 can determine times of day building 104 is likely to be occupied and/or is unlikely to be occupied based on any suitable information. For example, in some embodiments, energy management cloud 106 can determine predicted occupancy levels of building 104 based on calendar information received from a device associated with building 104 that indicates scheduled events. As another example, in some embodiments, energy management cloud 106 can predict occupancy levels of building 104 based on sensor data (e.g., motion sensor data, and/or any other suitable sensor data) that indicates movement within building 104.

Additionally, note that, in some embodiments, control of devices that contribute to energy usage within building 104 can be controlled via any suitable intermediary device associated with energy management cloud 106. For example, in some embodiments, an optimizer 112 can receive data from energy management cloud 106 and/or from energy database 110 and can identify any suitable rules for devices within building 104 that achieve any suitable outcome, such as reducing use of heating and/or air-conditioning, reducing usage of lights at times building 104 is unlikely to be occupied, and/or any other suitable outcome. In some such embodiments, optimizer 112 can use any suitable technique or combination of techniques to determine rules for devices within building 104. For example, in some embodiments, optimizer 112 can use any suitable machine learning algorithm(s) to identify times of day building 104 is unlikely to be occupied, to identify preferred temperatures in different areas of building 104, to determine rises in temperature in particular areas of building 104 due to sunlight through windows of building 104, and/or to determine any other suitable information.

In a more particular example, optimizer 112 can receive energy budget information from a tenant, energy pricing information (e.g., which can change based on energy demands), weather information, and building data from one or more devices and sensors to determine whether control instructions for one or more of the devices should be modified. Based on the output of the optimizer 112, a control instruction and/or a recommendation to modify a control instruction can be transmitted. For example, optimizer 112 can determine that dishwasher operation should be delayed to avoid peak-time power pricing. In continuing this example, a tenant can override the determination by optimizer 112 to continue operating the dishwasher. In addition, in some embodiments, optimizer 112 can use such feedback to modify future recommendations for modifying control instructions of devices in the building.

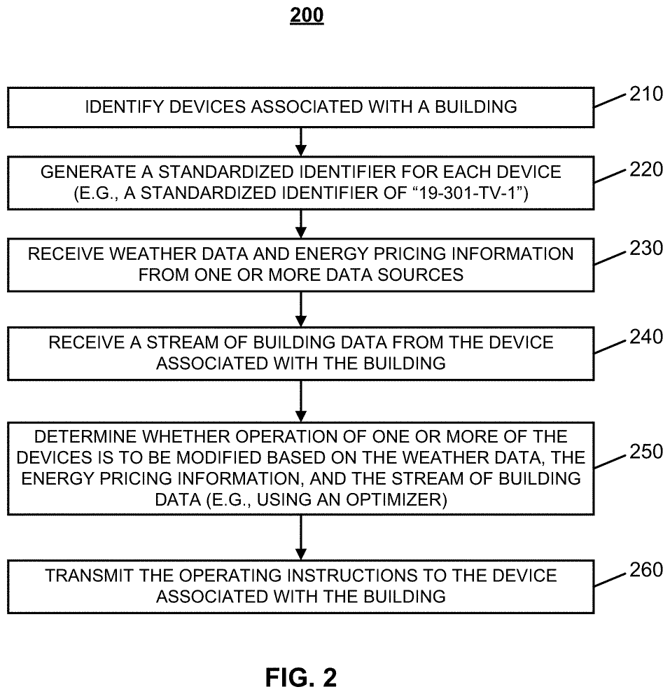

Turning to FIG. 2, an illustrative example 200 of a process for energy management is shown in accordance with some embodiments of the disclosed subject matter. In some embodiments, blocks of process 200 can be executed by any suitable device. For example, in some embodiments, blocks of process 200 can be executed by a server that provides control instructions to devices associated with a building.

At 210 of process 200, an energy management server can identify one or more devices and/or sensors associated with a building in any suitable manner and using any suitable technique(s). For example, in some embodiments, the energy management server can use any suitable device discovery protocol to identify the one or more devices connected to a communication network, such as a local Wi-Fi network in a home of a user, and/or any other suitable communication network. As a more particular example, in some embodiments, the energy management server can identify the one or more devices via mDNS, Discovery and Launch (DIAL), and/or using any other suitable protocol(s).

In some embodiments, the energy management server can identify any suitable information about each of the one or more identified devices. For example, in some embodiments, the energy management server can determine a type of device associated with each of the identified devices. As a more particular example, in some embodiments, the type of device can indicate that the identified device is a television device, that the identified device is an appliance plugged into an outlet, that the identified device is a temperature sensor, and/or any other suitable type of device. As another example, in some embodiments, the energy management server can determine a capability of each of the identified devices. As a more particular example, in some embodiments, the energy management server can determine whether each identified device is capable of receiving control instructions from the energy management server.

In another more particular example, upon receiving authorization and/or content, the energy management server can detect devices and/or sensors that have been plugged in and/or unplugged to an outlet and, in response, can determine a type of device and/or sensor. Additionally or alternatively, the energy management server can identify the type of device and/or sensor that has been plugged into an outlet and can generate a user interface that requests that a user, such as a tenant of a building, verify the device that has been plugged in.

In some embodiments, a device and sensor kit can be transmitted to a user for installation within the building. For example, each device and sensor kit can include 1) all in one sensors that monitors air quality (volatile organic compounds and carbon dioxide), 2) temperature and motion sensors, 3) thermostats, 4) smart power strips, and 5) a gateway. Upon installing the sensors and devices within the building, the energy management server can determine whether the devices and sensors from the kit are detected within the building. In a more particular example, the gateway can determine whether the devices and sensors from the kit are detected (e.g., over a communications network) and can transmit the device information that includes device identifiers and device type information to the energy management server.

It should be noted that, in some embodiments, the device and sensor kit can be transmitted to the user (e.g., a tenant) upon accessing a page using a computing device that provides an energy cost calculator. In response to inputting building-related information (e.g., size or square footage of a building, number of tenants, number of floors, typical energy costs, etc.), the energy cost calculator can determine a predicted energy cost savings to the user upon installation of the device and sensor kit and can provide the user with an opportunity to receive the device and sensor kit.

In some embodiments, at 220 of process 200, the energy management server can generate a standardized identifier for each identified device and/or sensor. For example, as described above, the energy management server can identify devices and/or sensors that are connected to various outlets in a building and convert a name associated with each of the identified devices and/or sensors to a standardized identifier. This can, for example, generate a set of standardized identifiers for a building, for a neighborhood, for multiple offices within an office building, etc.

It should be noted that a standardized identifier can include any suitable metadata in which devices and/or sensors are named by floor, room number, device type, and an index. In a more particular example, a standardized identifier can include a sequence of characters that includes a floor identifier followed by a room number identifier followed by a device type identifier and followed by an index number. In continuing this example, television devices can be identified as 19-301-TV-1, 19-302-TV-1, etc., while thermostat devices can be identified as 19-301-TSAT-1 and 19-302-TSAT-1. Such a naming schema can, for example, allow the energy management server described herein to determine which rooms of a building a television device is located and how to control the lighting devices and the thermostat devices in the room to prepare for an event (e.g., a presentation).

In some embodiments, at 230 of process 200, the energy management server can receive data from one or more external data sources. For example, the energy management server can receive weather information that includes temperature information, precipitation information, sunlight information, wind information, and other forecasts. In another example, the energy management server can receive energy pricing information, such as electricity grid pricing information that may vary across a given day based on energy demands.

In some embodiments, process 200 can receive the weather information and/or the energy pricing information from any suitable source. For example, in some embodiments, data and/or information can be received from a government entity that collects and/or maintains data such as weather information. In another example, in some embodiments, the energy management server can receive information indicating a weather forecast for a geographic region in which a building is located from a weather service, where the weather forecast that can indicate any suitable weather information, such as predicted temperatures, predicted storms, and/or any other suitable weather information. In yet another example, in some embodiments, data and/or information relating to energy pricing, energy demands, and/or status of an energy grid can be received from an energy provider.

In some embodiments, the energy management server can use a machine learning classifier to predict energy pricing information based on weather information, such as temperature information and sunlight information. For example, additionally or alternatively to receiving energy pricing information from a suitable source (e.g., an energy provider source), the energy management server can determine a predicted electricity price by providing weather information and historical electric grid pricing information to a corresponding energy pricing classifier. In response, the energy pricing classifier can provide, as output, a predicted electricity price based on the provided weather information. The energy management server can use the predicted electricity price and/or a combination of the predicted electricity price with electricity prices provided by one or more external sources to, for example, transmit control instructions to or recommend to modify the control of one or more devices associated with a building (e.g., based on tenant-inputted energy budget information).

In some embodiments, at 240 of process 200, the energy management server can receive a stream of building data from the identified devices and/or sensors associated with the building. For example, building systems that include the identified devices and/or sensors can track multiple real-time metrics about energy use and can communicate that information to the energy management server. Such building data can include data on occupancy, interior temperature, airflow, and electricity usage. In a more particular example, the energy management server can receive a stream of building data from a gateway device that has been connected to a communications network within a building.

In some embodiments, the stream of building data can include the standardized device identifier, a timing information associated with a piece of building data, and the building data itself. Building data can include, for example, energy usage indications (e.g., an application is currently running), device connection information (e.g., an appliance has been plugged into an outlet), sensor information (e.g., a temperature sensor reading, a motion sensor reading, occupancy sensor readings, people counter readings, etc.), plug load information, ventilation information, heating information from a heating system, cooling information from a cooling system, etc.

In some embodiments, the energy management server can receive building data from other suitable sources, such as intermediary devices. For example, in some embodiments, the energy management server can receive data through a building management system (e.g., such as a building management system 118 of FIG. 1 that is connected to the devices and/or sensors of a building). As a more particular example, in some embodiments, the building management system can receive data from any devices that contribute to energy usage within the building and can transmit the received data to the energy management server. As another more particular example, in some embodiments, the energy management server can receive data through a thermostat cloud server (e.g., that indicates data associated with one or more thermostat devices within the building, such as current temperature, preferred temperatures during particular times of the day, occupancy information as to when tenants are located proximal to a thermostat, etc.) and/or a lighting cloud server (e.g., that indicates data associated with one or more lighting devices, such as the location of a lighting device within a building, whether a lighting device is currently turned on, the particular times of day the lighting device is turned on, occupancy information as to when tenants are located proximal to a lighting device, etc.). Note that, in some embodiments, data received by the energy management server can be processed to be in any suitable format prior to storage in an energy database. For example, in some embodiments, the energy management server can use a format translator to convert data received from multiple sources (e.g., from a building management system, from a thermostat cloud server, from a lighting cloud server, etc.) to a common format prior to storage in the energy database.

In some embodiments, the energy management server can derive building data, such as occupancy information, from other building data. For example, the energy management server can determine occupancy information based on one or more of plug load usage in a particular zone of a building, data from a motion sensor, data from a room calendar or scheduling system, data from density people counters, etc. In a more particular example, the energy management server can receive data from any other suitable sources, such as a calendar device or multiple calendar devices associated with the building 104. For example, in some embodiments, the energy management server can receive event data from a calendar device associated with the building that indicates dates and/or times the building is likely to be occupied and/or date and/or times portions of the building is likely to be occupied. As a more particular example, in some embodiments, the event data can indicate dates and/or times a conference room within the building is likely to be occupied. As another more particular example, in some embodiments, the event data can indicate dates and/or times an atypical evening event or an atypical weekend event is to be held at an office building. The energy management server can use this event information from the calendar system to predict whether one or more portions of a building are occupied. As described hereinbelow, such occupancy information can be used by an optimizer of the energy management server to determine control information for one or more devices within a building (e.g., that a smart power strip should be turned off, that a heating or cooling system can be turned off or modified to reduce energy consumption, etc.).

In some embodiments, the energy management server can obtain the same type of building data from multiple sources. For example, occupancy information can be received from an occupancy sensor, a thermostat, a lighting device, a camera security system, a scheduling system, plug load usage information, etc. In continuing this example, a machine learning classifier can receive such information to predict whether it is likely that a portion of a building is occupied. Alternatively, in some embodiments, the energy management server can determine that a portion of the building is occupied based on one data source indicating that there is an occupant (or a particular number of occupants).

Referring back to FIG. 2, in some embodiments, the energy management server can determine whether operation of one or more of the devices in the building should be modified at 250 of process 200. For example, the optimizer shown in FIG. 1 can receive the stream of building data along with weather information and energy pricing information to determine whether one or more actions should be initiated.

For example, the energy management server can set dynamic zone temperatures based upon occupancy information, predicted occupancy information, comfort feedback from tenants (e.g., a tenant application in which the tenant provides feedback regarding comfort), learned preferences (e.g., based on user-inputted thermostat settings), and/or contextual information (e.g., indoor zone temperature, outdoor weather including temperature and humidity, dress code with seasonal and geographical context, time to reach a set point, energy pricing, greenhouse gas intensity, and holiday schedule).

In another example, the energy management server can turn off or on plug loads or outlets when the energy management server determines that the plug load or outlet is not needed based on occupancy information, predicted occupancy information, device type, time of day, and/or energy pricing.

In yet another example, the energy management server can adjust lighting and/or shading by controlling one or more lighting devices and one or more shade devices based on occupancy, temperature, learned preferences, and/or interior light levels (e.g., impacted by outdoor brightness).

In some embodiments, the optimizer of the energy management server can be used to modify energy usage within buildings. For example, in some embodiments, the output of the optimizer of the energy management server can be interpreted to control devices that contribute to energy usage within a building, such as thermostats, lights and light switches, window shades, and building equipment (e.g., fans, heat pumps, etc.) such that overall energy usage within the building can be reduced.

It should be noted that the operation of a device can be controlled in any suitable manner and based on any suitable information. For example, in some embodiments, the energy management server can cause one or more thermostats of a building to be set to particular temperatures such that a heating system is less likely to be activated and/or an air-conditioning system is less likely to be activated at times of day when the building is unlikely to be occupied. As a more particular example, in an instance in which the building is determined to be unlikely to be occupied at night and/or on weekends (e.g., in the case of an office building), the energy management server can cause a thermostat to be set at a higher temperature during summer months and/or at a lower temperature during winter months. As another example, in some embodiments, the energy management server can cause lights of a building to be deactivated and/or turned off during times of day the building and/or days of the week the building is unlikely to be occupied. As yet another example, in some embodiments, the energy management server can cause window treatments and/or window shades of windows of a building to be drawn and/or adjusted in transparency based on any suitable information, such as an amount of outdoor sunlight. As a more particular example, in an instance where the energy management server determines that there is more than a predetermined amount of outdoor sunlight, the energy management server can cause window shades to be opened and/or a transparency of window treatments to be increased, thereby allowing a room of the building corresponding to the windows to be naturally heated rather than using a heating system of the building to heat the building.

In some embodiments, the energy management server described herein can receive data from any suitable devices or sensors within the building (e.g., thermometers and/or thermostats, lights, light sensors, motion sensors, and/or any other suitable devices or sensors) and/or any other suitable information (e.g., weather forecast information, calendar information, and/or any other suitable information) and can aggregate the received data in any suitable manner. For example, to prevent glare, help manage temperature, and control lights, shades, and/or electrochromic glass, the energy management server described herein can receive data from one or more light and solar radiation sensors. In another example, to adjust convenience electronics or appliances having flexibility in run times (e.g., a dishwasher in a residential home, monitors in a business during night hours, etc.), the energy management server described herein can receive data from one or more plug load monitors that are in select outlets and/or appliances. In yet another example, the energy management server described herein can receive data from one or more sensors for smoke, temperature, and air quality (e.g., carbon dioxide, volatile organic compounds, humidity, carbon monoxide, etc.). In a further example, to determine when heating, cooling, convenience plug loads, and lighting changes can save energy, the energy management server described herein can receive data from one or more occupancy sensors and/or integrations with access control systems. In some such embodiments, the energy management server can analyze the received data to determine a manner in which devices that contribute to energy usage within the building (e.g., thermostats, lights, window shades, building equipment, etc.) are to be controlled and/or set to minimize energy usage. For example, in some embodiments, the energy management server can receive any suitable data or information and can determine rules or parameters for thermostats, lights, etc. within a building that will reduce or minimize energy usage. As a more particular example, in some embodiments, the energy management server can determine that a particular building is unlikely to be occupied on weekends and that lights of the building are therefore to be turned off on weekends, as described above. In some embodiments, the energy management server can use any suitable algorithms to determine rules or parameters for devices that contribute to energy usage within a building.

It should be noted that, in some embodiments, the energy management server can train a model that predicts whether the operation of one or more devices in a building should be adjusted or otherwise modified using any suitable information, such as building data, tenant-inputted preference information, energy pricing information, energy usage information, weather information, etc. In some embodiments, the energy management server can train the model using any suitable technique or combination of techniques. Additionally, note that, in some embodiments, the model can include any suitable type of algorithm(s), such as any suitable type of machine learning model, and/or any other suitable type of algorithm(s). In some embodiments, the energy management server can train the model using the building data, the weather information, and/or the energy pricing information in any suitable manner. For example, in some embodiments, the energy management server can generate a training set that includes any suitable number of training samples (e.g., one hundred, one thousand, ten thousand, one million, and/or any other suitable number) from the building data, the weather information, and/or the energy pricing information.

Note that, in some embodiments, building information (e.g., a location of a building, a type of activity associated with a building, a height of a building, a shape of a building, and/or any other suitable building information) can correspond to inputs of each training sample.

Note that, in some embodiments, the model can include any suitable type of algorithm(s). For example, in some embodiments, the energy management server can train a neural network with any suitable number of layers. Note that in some embodiments, the energy management server can train the model using a subset of the training samples (e.g., 70% of the training samples, 80% of the training samples, and/or any other suitable subset). In some such embodiments, the energy management server can then test a trained model using a remaining portion of the training samples to determine an accuracy of the trained model.

Referring back to FIG. 2, in some embodiments, the energy management server can transmit the operating instructions or control instructions to the device associated with the building at 260 of process 200. For example, in response to the determined action, the energy management server can determine which devices are impacted by the action using the standardized identifier (e.g., which devices are in particular locations) and can transmit control instructions that automatically cause the corresponding device to perform the adjustment in operation.

Alternatively, in some embodiments, the energy management server can transmit a recommendation (e.g., via a user interface, via a notification on a device, etc.) that suggests an adjustment in the operation of a device within the building. For example, the energy management server can present a user interface that suggests a temperature adjustment by changing a thermostat device to a particular temperature at a particular time and opening the windows. It should be noted that, in some embodiments, the recommendation can be transmitted in response to determining that the energy management server cannot cause the corresponding device to automatically perform the adjustment in operation (e.g., lack of connectivity to the device, manual action such as opening a window, etc.). It should also be noted that, in some embodiments, the recommendation can be transmitted in response to determining that a user-selected energy budget is deemed high, thereby providing the tenant with additional flexibility in energy usage.

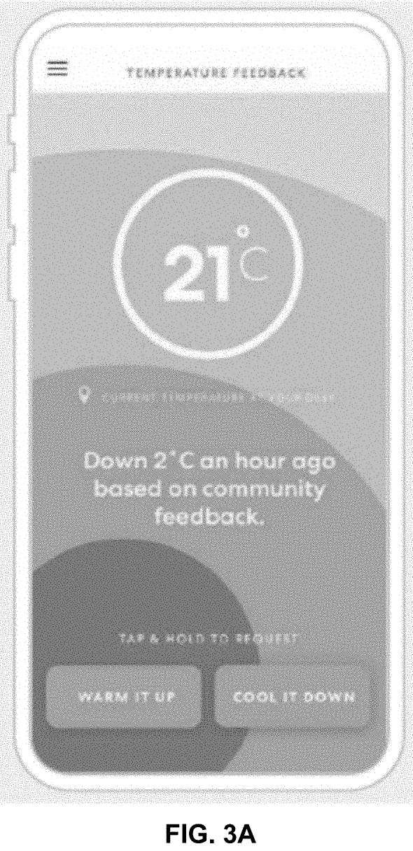

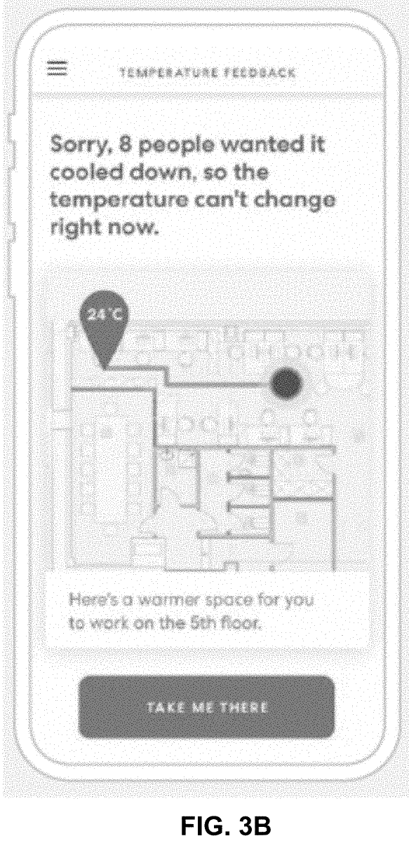

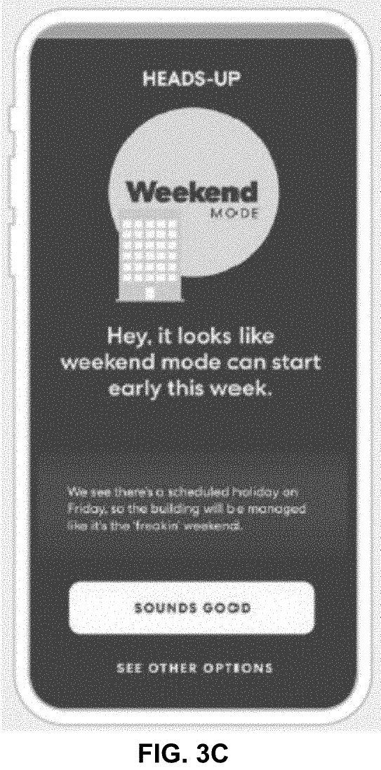

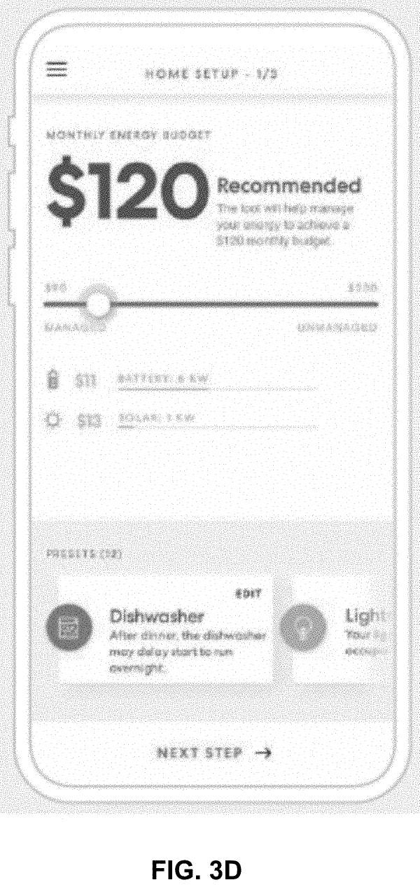

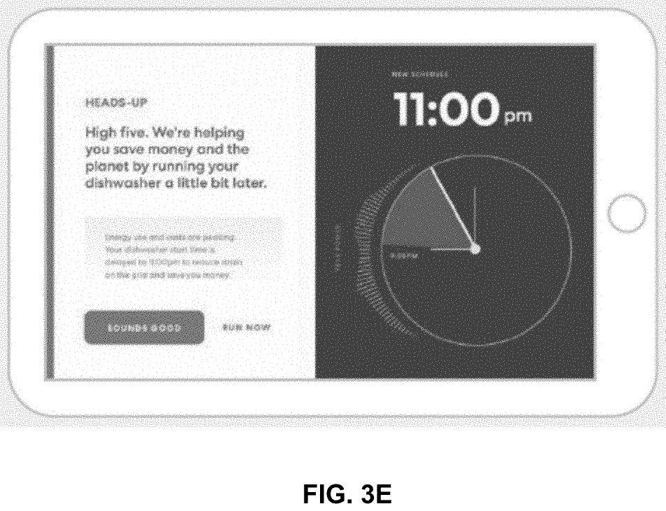

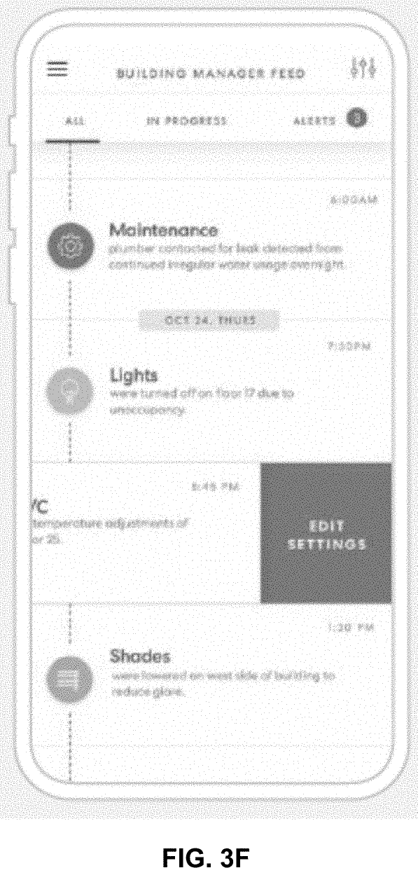

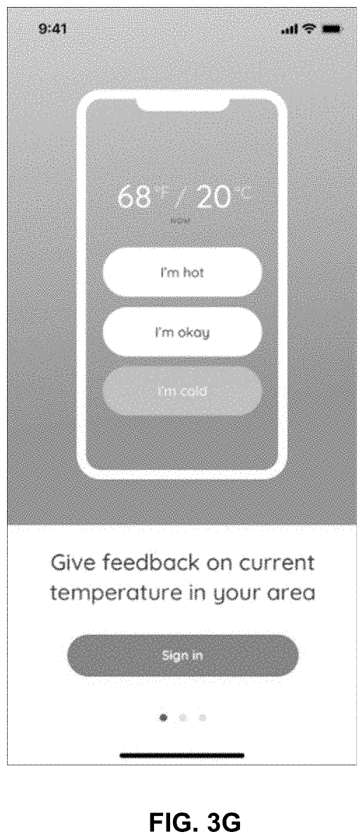

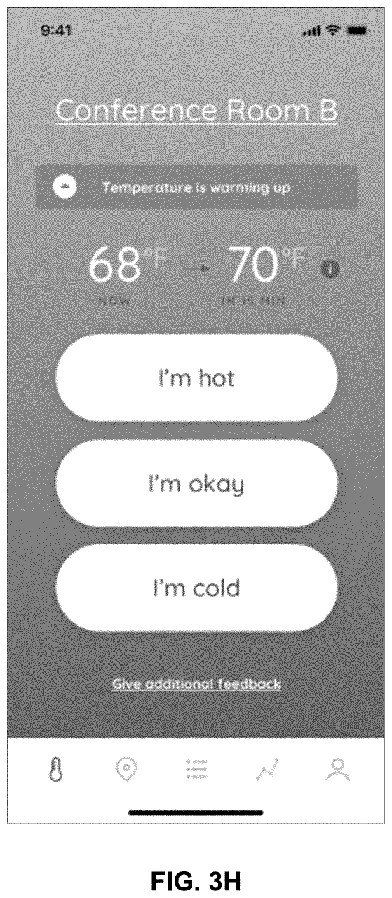

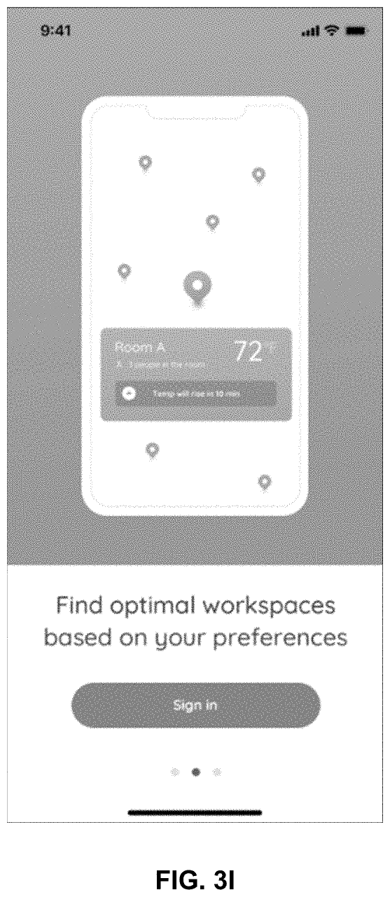

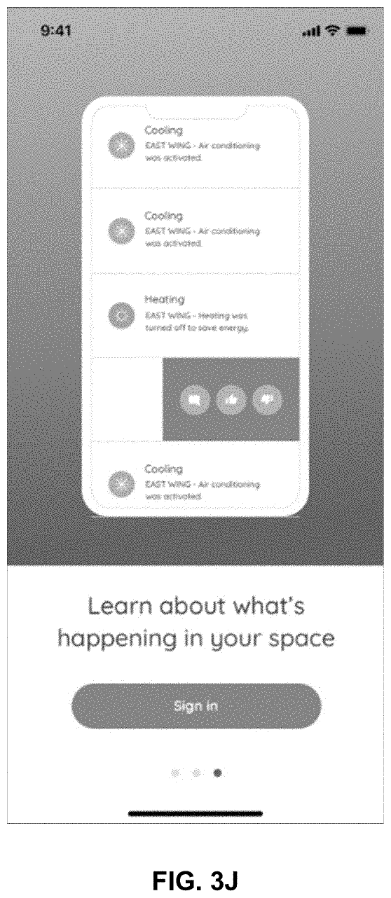

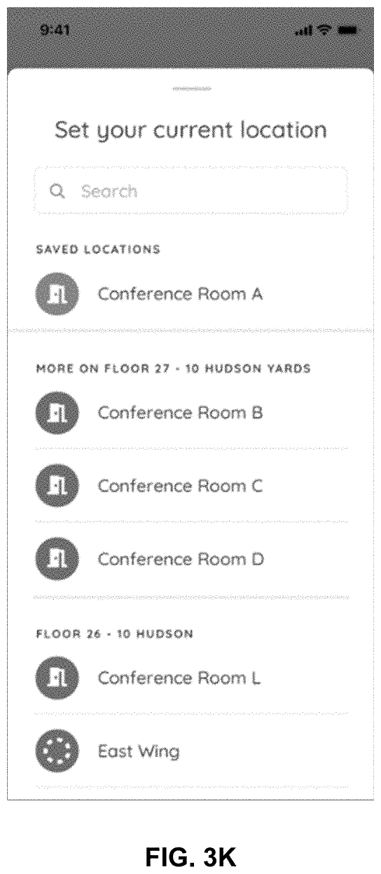

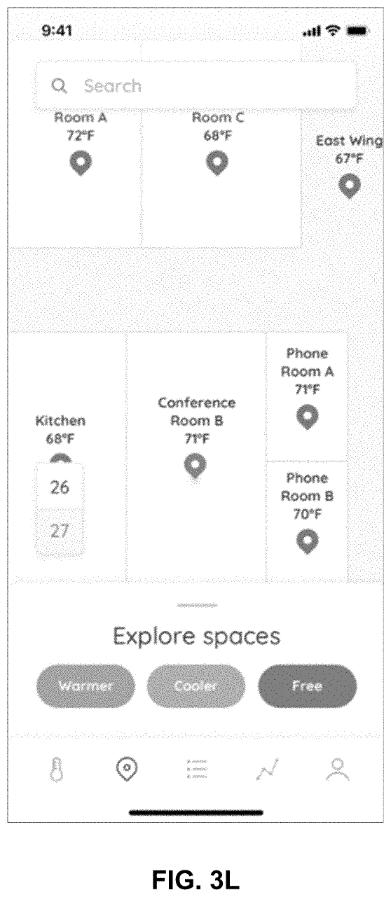

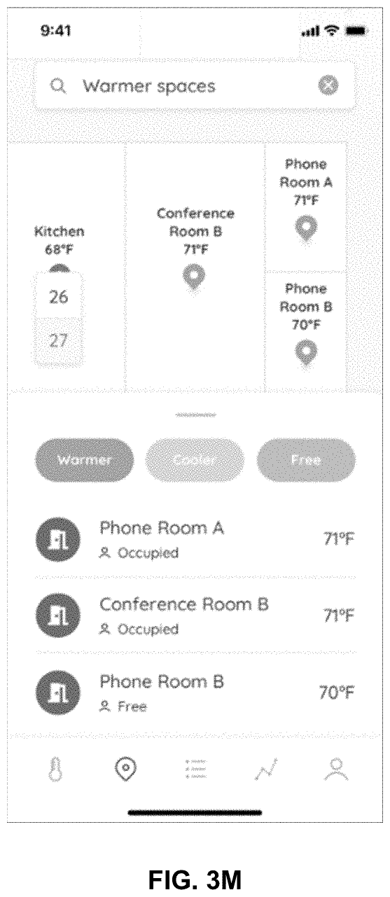

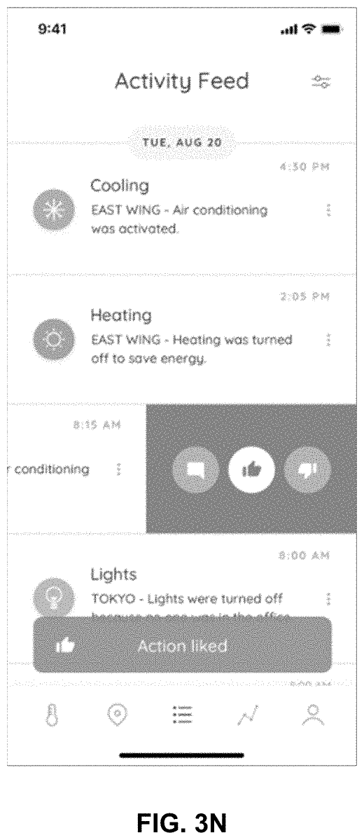

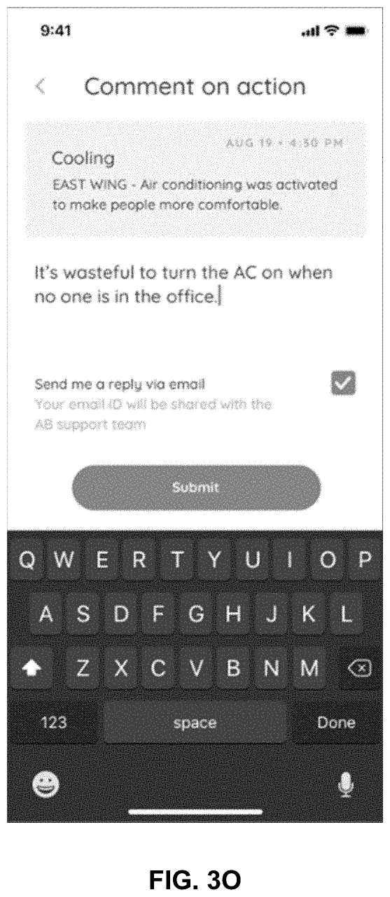

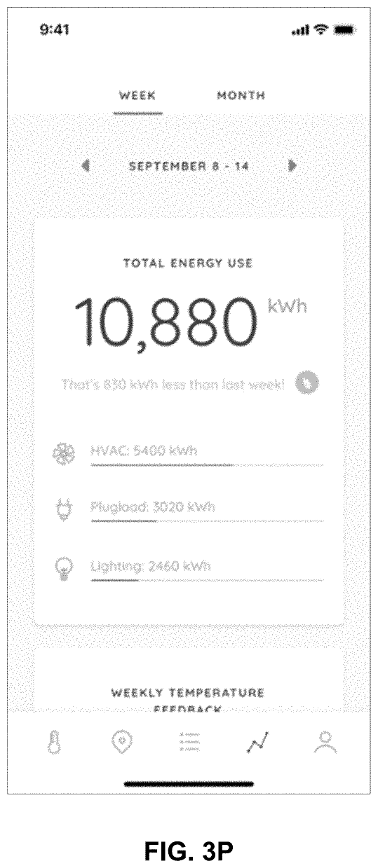

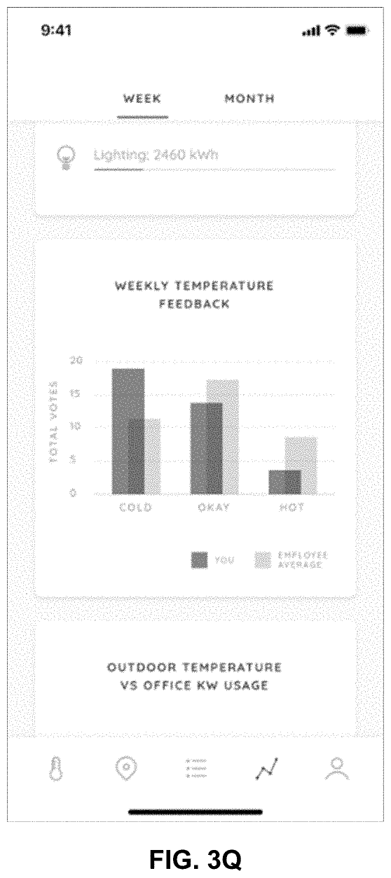

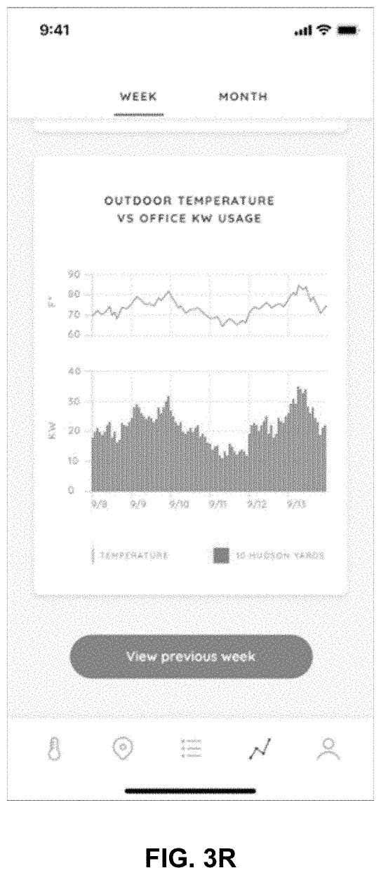

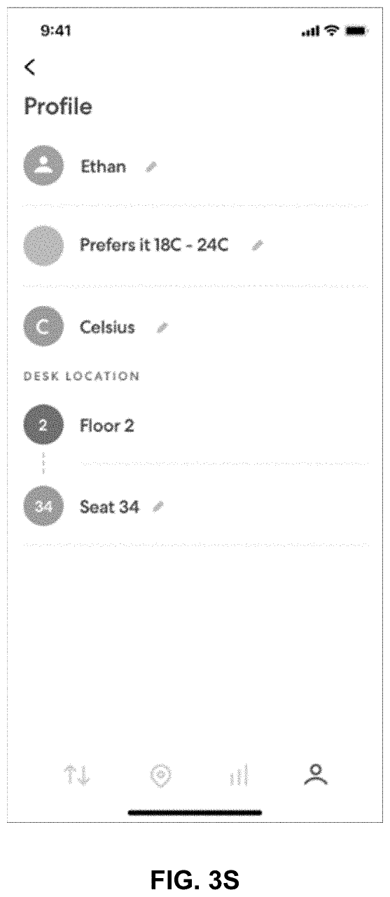

Additionally, in some embodiments, the energy management server can present a number of user interfaces to indicate the automated or suggested adjustments to the devices in the building. For example, as shown in FIG. 3E, the energy management server can present an interface on a tenant device indicating that the optimizer of the energy management server has determined that a dishwasher appliance should be delayed in operation based on energy costs, energy budget information, and current energy usage. As also shown in FIG. 3E, the energy management server can provide the tenant with an opportunity to confirm the adjustment (e.g., “SOUNDS GOOD”) or to override the adjustment to the dishwasher appliance (e.g., “RUN NOW”). In another example in which an office scheduler is implemented, as shown in FIG. 3C, the energy management server can present an interface on a facility manager device indicating that the optimizer of the energy management server has determined that an operation mode for devices in the building can be initiated at a particular time. In a more particular example, based on occupancy information, predicted occupancy information, and energy usage, the energy management server can determine that a weekend operation mode for the building can be implemented at a particular time. As also shown in FIG. 3C, the energy management server can provide the facility manager with an opportunity to confirm the adjustment (e.g., “SOUNDS GOOD”) or to override the adjustments to the building (e.g., “SEE OTHER OPTIONS”).

It should also be noted that the energy management server can receive energy budget information from a user interface presented on a tenant device. For example, as shown in FIG. 3D, the energy management server can present an interface on a tenant device that provides a tenant with an opportunity to input monthly energy budget information. In addition, as also shown in FIG. 3D, the interface can provide the user with an opportunity to confirm detected devices in the home (e.g., devices that are connected to the gateway), provide the user with an opportunity to add devices and/or sensors in the home, provide the user with an opportunity to remove devices and/or sensors in the home that the user does not wish to be considered and/or controlled by the energy management server, etc.

It should be noted that, in some embodiments, the input of budget information by a tenant can determine an amount of automation by the energy management server. For example, in some embodiments, a lower energy budget set by a tenant using the interface shown in FIG. 3D can cause the energy management server to provide a greater amount of automation of the operation of energy systems and devices in the building using an automated scheduler. In another example, in some embodiments, a higher energy budget set by a tenant using the interface shown in FIG. 3D can cause the energy management server to provide a lesser amount of automation of the operation of energy systems and devices in the building using an automated scheduler. For example, automated control instructions can be provided as recommendations to a tenant using a tenant application. In another example, bypass options or override options can be activated on the user interface based on the higher energy budget.

In some embodiments, the energy management server can receive tenant feedback using a tenant application executing on a tenant device. For example, as shown in FIG. 3A, the energy management server can present an interface on a tenant device that indicates a temperature in a particular zone has been adjusted based on feedback received from other tenants (e.g., down two degrees). As also shown in FIG. 3A, the interface on the tenant device can provide the tenant with the opportunity to provide additional feedback to continue to adjust the temperature of the particular zone (e.g., “WARM IT UP” or “COOL IT DOWN”). As such, the optimizer of the energy management server can provide rule-based temperature adjustment suggestions or automation based on zone or location information, occupancy information, occupancy patterns, weather information, indoor zone temperature information, and/or tenant feedback (e.g., votes to adjust the temperature in a particular direction).

In another example, FIG. 3G shows an illustrative example of a user interface that prompts a tenant to provide feedback on the current temperature in an area of a building. In some embodiments, the tenant can launch an energy management application on a user device, access a temperature feedback interface, and provide the temperature feedback for transmission to the energy management system (e.g., to respond to the feedback) and/or a facilities manager if the building type is an office building.

In continuing this example, prior to presenting the user interface shown in FIG. 3G, the energy management server can transmit a notification to a tenant that has installed a corresponding energy management application on a user device. Such a notification that indicate that a facilities manager is prompting the tenant to vote or otherwise provide input on the current temperature in the building.

As also shown in FIGS. 3G and 3H, these user interfaces can indicate the current temperature in a particular portion of a building (e.g., 68 degrees), that the temperature is currently being adjusted (e.g., the temperature is warming up), and the target temperature for that particular portion of the building (e.g., the target temperature is 70 degrees).

In some embodiments, as shown in FIG. 3H, the user interface can indicate a current location associated with a tenant. For example, FIG. 3H indicates that the tenant is currently located in “Conference Room B” and that feedback on the current temperature is associated with that location.

In some embodiments, the energy management server can allow a tenant to provide location information corresponding to the tenant in any suitable manner. For example, in some embodiments, the energy management server can request authorization from the tenant to receive location information from a user device associated with the tenant. In a more particular example, upon installing an energy management application, the energy management application can request specific authorization from the tenant to receive location information corresponding to the user device. Additionally or alternatively, in some embodiments, a user interface can be presented that allows the tenant to indicate a current location. For example, as shown in FIG. 3K, the user interface can allow the tenant to search for and select a particular location within an office building from multiple locations (e.g., a saved location of “Conference Room A,” other areas that are nearby, etc.).

In some embodiments, the energy management server can provide feedback to a tenant using a tenant application executing on a tenant device. For example, as shown in FIG. 3B, in response to receiving a request from the tenant to adjust the temperature and in response to determining that the temperature cannot be adjusted (e.g., based on the output of the optimizer receiving location information, occupancy information, occupancy patterns, weather information, indoor zone temperature information, tenant voting information, etc.), the energy management server can present an interface on a tenant device that indicates that the temperature cannot be adjusted at this time. As also shown in FIG. 3B, the energy management server can identify one or more regions within the building that may be more comfortable for the tenant and can, via the interface, present a map of the building indicating a zone that may be more comfortable for the tenant based on the request. In continuing this example, in the implementation of an office scheduler, the energy management server can use building data, such as occupancy information from occupancy sensors and plug load information, to determine whether a space, such as a desk or an office, is available for the tenant to relocate. In some embodiments, the interface can present directions to the zone having the desired temperature corresponding to the tenant request.

In a more particular example, the energy management server can present a user interface on an energy management application that allows a tenant of an office building to find an optimal workspace based on user preferences. For example, as shown in FIG. 3I, in response to signing into a tenant application, the energy management server can use the optimizer to determine an optimal workspace for a tenant within an office building given one or more user preferences. For example, as shown in FIG. 3S, the energy management application executing on a user device of a tenant can provide a tenant profile in which the tenant can input preferences, such as tenant information, preferred temperatures, current location information, location authorizations, etc. In some embodiments, the preferences shown in FIG. 3S can be preferences that have been determined based on previous inputs provided by the tenant (e.g., a request to adjust the temperature to warmer temperatures, a request to turn on an air conditioning unit, a request to run a dishwasher, a request to reserve a particular workstation, etc.).

Continuing the above-mentioned example, the energy management application executing on a user device of a tenant can allow the tenant to explore a building based on user preferences. For example, as shown in FIG. 3L, the user interface can provide user with various filters to locate spaces within the building that would be considered comfortable for the tenant (e.g., filter by “warmer” spaces, “cooler” spaces, or available spaces). As shown in FIG. 3M, in response to the user selecting “warmer” spaces, the energy management application can present locations in the office building having temperatures that are warmer than the temperature of the current location. As also shown in FIG. 3M, the user interface can include a map of the locations, the availability of the location (e.g., free or occupied), and temperature information associated with the particular location. As mentioned above, in response to selecting a location, the energy management application can reserve the location for the user (e.g., reserve a workspace at the particular location) and/or can provide directions to the “warmer” location.

In some embodiments, the energy management server can present an activity feed that indicates automated and/or suggested actions on the devices in the building. For example, as shown in FIG. 3F, the activity feed can include particular actions that have been suggested at particular times by the energy management system. In continuing this example, a user (e.g., a facilities manager) can select the action item from the activity feed to instruct the energy management system to initiate the action in one or more devices, to provide control instructions modify the settings of the device (e.g., “EDIT SETTINGS”), to obtain detailed information on the proposed adjustments to the one or more devices, etc. In addition, each action item in the activity feed can also indicate the reason for the action (e.g., lights were turned off at 7:30 PM on floor 17 due to unoccupancy, shades were lowered on the west side of the building at 1:30 PM to reduce glare, etc.). In another example, the activity feed can include detection events, such as that a new device has been detected (e.g., a television device at a particular outlet), that a device has been removed (e.g., a television device has been unplugged from a particular outlet), that a device has been changed (e.g., a fan was plugged into a particular outlet but the current device is unlikely to be a fan), etc. In continuing this example, the activity feed can provide a user (e.g., a facilities manager) with an opportunity to confirm the detected device (e.g., that the energy management server has identified the device correctly, that the device has indeed changed to a different device type, etc.).

It should be noted that, although the embodiments described above show an activity feed for a facilities manager of an office building, this is merely illustrative. In some embodiments, an energy management application executing on a user device of a tenant can provide the tenant with an activity feed to, for example, provide the tenant with updated information on energy consumption and energy management of a building.

Turning to FIG. 3J, in response to signing in to a energy management application, the energy management application can present an activity feed corresponding to a building. For example, as shown in FIG. 3J, the activity feed can indicate a particular action associated with one or more devices (e.g., heating, cooling, lights, shades, dishwasher, dryer, etc.) was executed at a particular time. The action, in some embodiments, can be accompanied by a reason that the action was executed (e.g., a heating system was turned off to save energy, lights were turned off at a particular location due to the location not being occupied, etc.).

As shown in FIG. 3N, the tenant using the energy management application can provide feedback to an action presented in the activity feed. For example, the tenant can provide a positive or negative indication of endorsement (e.g., a like or a dislike) associated with an action presented in the activity feed. In a more particular example, the tenant using the energy management application can provide a negative indication to indicate that a device (e.g., a smart power outlet) should not have been turned off due to lack of occupancy as the tenant was using a workspace associated with that device. In another more particular example, the tenant using the energy management application can provide a positive indication to indicate that a number of devices associated with a conference room (e.g., lights, a display device, a heating or cooling system, etc.) were correctly turned off as no one was occupying the conference room and there were no planned meetings for that conference room in the scheduling system.

As shown in FIGS. 3N and 3O, the tenant using the energy management application can provide a comment to an action presented in the activity feed. For example, as shown in FIG. 3O, the tenant can provide a textual comment via the energy management application regarding the activation of an air conditioning unit at a particular location (e.g., east wing). In turn, the textual comment can be transmitted to the energy management system to determine whether the optimizer was incorrect to automatically cause the air conditioning unit to turn on. Additionally or alternatively, the textual comment can be transmitted to a facilities manager to determine whether the action recommended by the energy management system should have been overridden.

In some embodiments, the energy management application can provide a user, such as a tenant or a facilities manager, with energy consumption information. For example, as shown in FIG. 3P, the energy management application can provide information relating to total energy use and information as to which devices or categories of devices contributed to the energy usage (e.g., HVAC vs. plug load vs. lighting). In another example, as also shown in FIG. 3P, the energy management application can provide an indication as to whether the energy consumption for a given time period (e.g., this week) was reduced from a previous time period (e.g., last week). In yet another example, as shown in FIG. 3Q, the energy management application can provide aggregated feedback information, such as the number of votes received from tenants to perform an adjustment to the operation of a device in the building (e.g., the tenant requested that the temperature is adjusted to a cooler temperature eighteen times in a given week while the average tenant made that request ten times). In a further example, as shown in FIG. 3R, the energy management application can present weather information (e.g., outdoor temperature information) in comparison with energy usage in the building. As also shown in FIG. 3R, the energy management application can allow the user to review these comparisons for previous time periods.

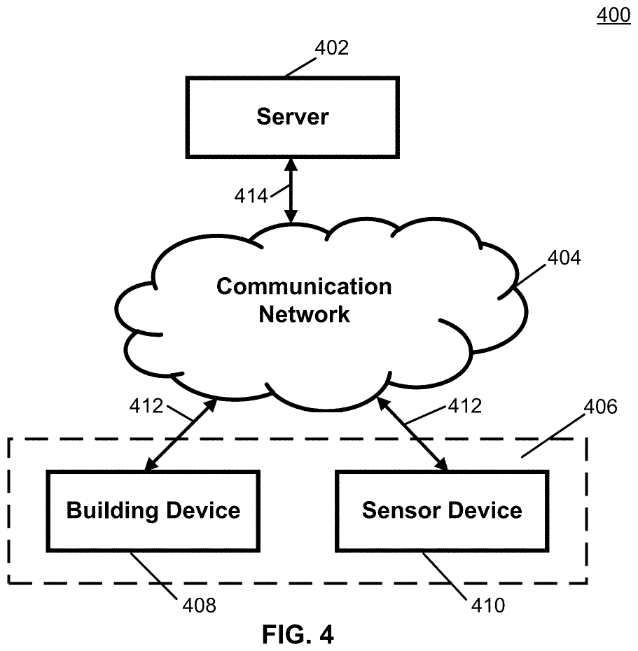

Turning to FIG. 4, an illustrative example 400 of hardware for energy management that can be used in accordance with some embodiments of the disclosed subject matter is shown. As illustrated, hardware 400 can include a server 402, a communication network 404, and/or one or more user devices 406, such as user devices 408 and 410.

Server 402 can be any suitable server(s) for storing information, data, programs, and/or any other suitable content. For example, in some embodiments, server 402 can store any suitable building energy data, such as information from energy-related sensors in a building (e.g., thermostat devices, lighting devices, automated window shade devices, heating systems, cooling systems, ventilation systems, etc.), information from external data sources (e.g., weather information, electricity grid pricing information, etc.), etc. In some embodiments, server 402 can execute any suitable functions for energy management of a building. For example, as described above in connection with FIG. 2, server 402 can determine whether to adjust or modify the operation of one or more devices in a building based on received or derived information, such as occupancy information, current temperature information, weather information, and energy pricing information. In another example, as described above in connection with FIG. 2, server 402 can transmit a control instruction that automatically adjusts the operation of a device in a building or can provide a recommendation to initiate such a control instruction.

Communication network 404 can be any suitable combination of one or more wired and/or wireless networks in some embodiments. For example, communication network 404 can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 406 can be connected by one or more communications links (e.g., communications links 412) to communication network 404 that can be linked via one or more communications links (e.g., communications links 414) to server 402. The communications links can be any communications links suitable for communicating data among user devices 406 and server 402 such as network links, dial-up links, wireless links, hard-wired links, any other suitable communications links, or any suitable combination of such links.

User devices 406 can include any one or more user devices suitable for detecting the presence of devices and/or sensors within a building, communicating building data, presenting user interfaces for initiating adjustments to the operation of one or more devices in a building, etc.

For example, in some embodiments, user devices 406 can include one or more building devices 408. Examples of building devices can include appliances (e.g., a refrigerator, a washer/dryer, a dishwasher, a fan, and/or any other suitable devices), a heating system, a cooling system, a ventilation system, a lighting device, a camera or imaging device (e.g., an outdoor camera, an infrared imaging device, a thermal imaging device, a LIDAR imaging device, etc.), a display device, a mobile device, a gaming device, and/or a communications device (e.g., a gateway, a Wi-Fi access point, a wireless backhaul system, etc.).

In another example, in some embodiments, user devices 406 can include one or more sensor devices 410. Examples of sensor devices can include an air quality sensing device, a temperature sensing device, a pressure sensing device, a sound or noise sensing device, a light sensing device, a humidity sensing device, an occupancy sensing device, etc.

Although server 402 is illustrated as one device, the functions performed by server 402 can be performed using any suitable number of devices in some embodiments. For example, in some embodiments, multiple devices can be used to implement the functions performed by server 402.

Although two user devices 408 and 410 are shown in FIG. 4 to avoid over-complicating the figure, any suitable number of user devices, and/or any suitable types of user devices, can be used in some embodiments.

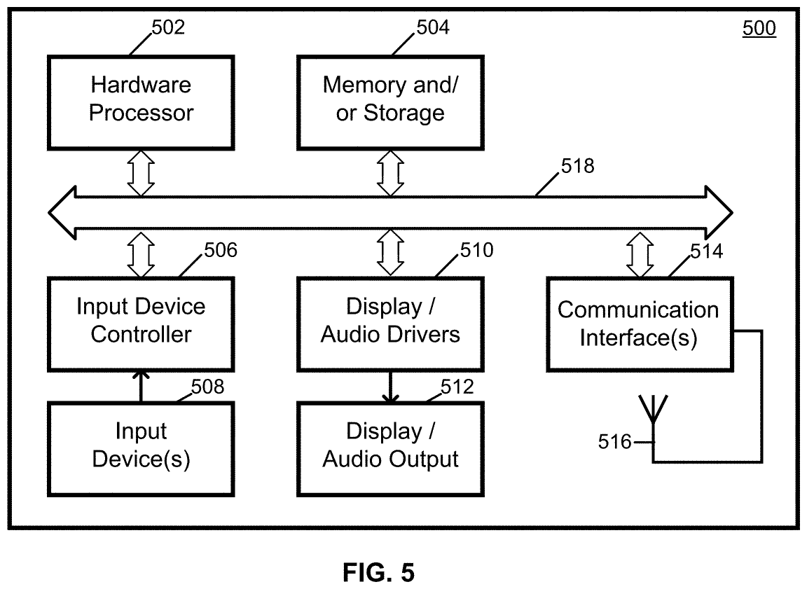

Server 402 and user devices 406 can be implemented using any suitable hardware in some embodiments. For example, in some embodiments, devices 402 and 406 can be implemented using any suitable general purpose computer or special purpose computer. For example, a mobile phone may be implemented using a special purpose computer. Any such general purpose computer or special purpose computer can include any suitable hardware. For example, as illustrated in example hardware 500 of FIG. 5, such hardware can include hardware processor 502, memory and/or storage 504, an input device controller 506, an input device 508, display/audio drivers 510, display and audio output circuitry 512, communication interface(s) 514, an antenna 516, and a bus 518.

Hardware processor 502 can include any suitable hardware processor, such as a microprocessor, a micro-controller, digital signal processor(s), dedicated logic, and/or any other suitable circuitry for controlling the functioning of a general purpose computer or a special purpose computer in some embodiments. In some embodiments, hardware processor 502 can be controlled by a server program stored in memory and/or storage of a server, such as server 402. In some embodiments, hardware processor 502 can be controlled by a computer program stored in memory and/or storage 504 of user device 406.

Memory and/or storage 504 can be any suitable memory and/or storage for storing programs, data, and/or any other suitable information in some embodiments. For example, memory and/or storage 504 can include random access memory, read-only memory, flash memory, hard disk storage, optical media, and/or any other suitable memory.

Input device controller 506 can be any suitable circuitry for controlling and receiving input from one or more input devices 508 in some embodiments. For example, input device controller 506 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 510 can be any suitable circuitry for controlling and driving output to one or more display/audio output devices 512 in some embodiments. For example, display/audio drivers 510 can be circuitry for driving a touchscreen, a flat-panel display, a cathode ray tube display, a projector, a speaker or speakers, and/or any other suitable display and/or presentation devices.

Communication interface(s) 514 can be any suitable circuitry for interfacing with one or more communication networks (e.g., computer network 404). For example, interface(s) 514 can include network interface card circuitry, wireless communication circuitry, and/or any other suitable type of communication network circuitry.

Antenna 516 can be any suitable one or more antennas for wirelessly communicating with a communication network (e.g., communication network 404) in some embodiments. In some embodiments, antenna 516 can be omitted.

Bus 518 can be any suitable mechanism for communicating between two or more components 502, 504, 506, 510, and 514 in some embodiments.

Any other suitable components can be included in hardware 500 in accordance with some embodiments.

In some embodiments, at least some of the above described blocks of the processes of FIGS. 1 and 3 can be executed or performed in any order or sequence not limited to the order and sequence shown in and described in connection with the figures. Also, some of the above blocks of FIGS. 1 and 3 can be executed or performed substantially simultaneously where appropriate or in parallel to reduce latency and processing times. Additionally or alternatively, some of the above described blocks of the processes of FIGS. 1 and 3 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described herein collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personal information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, methods, systems, and media for energy management are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for energy management in buildings, the method comprising:
identifying a plurality of devices associated with a building;
generating a standardized identifier for each of the plurality of devices, wherein the standardized identifier includes location information, a device type, and an index number;
receiving weather data and energy pricing information;
receiving, from the plurality of devices, a stream of building data, wherein each piece of building data has a data type and is associated with the standardized identifier for that device;
determining whether operation of one or more of the plurality devices is to be modified based on the weather data, the energy pricing information, and the stream of building data;
in response to determining that the operation of a device is to be modified based on the weather data, the energy pricing information, and the stream of building data, determining operating instructions based on the device type and the location information from the standardized identifier of the device; and
transmitting the operating instructions to the device associated with the building.

2. The method of claim 1, wherein the plurality of devices includes one or more of: a lighting sensor, a solar radiation sensor, an occupancy sensor, a temperature sensor, an air quality sensor, a smoke detector, a ventilation system, a heating system, a cooling system, an access control system, a media device, a thermostat device, a window shade device, an electrochromic glass device, a lighting system, a home appliance, and a smart power outlet.

3. The method of claim 1, further comprising:
determining a user-selected energy usage criterion; and
based on the user-selected energy usage criterion, causing a user interface to be presented on a computing device that requests a user initiate the modification of the operation of the device with the determined operating instructions.

4. The method of claim 1, wherein the modification of the operation of the device is determined using an optimizer that receives the weather data, the energy pricing information, and the stream of building data as input.

5. The method of claim 1, wherein a second portion of building data is derived from a first portion building data in the stream of building data.

6. The method of claim 1, further comprising:
determining that the device associated with the building is not capable of being controlled via the transmitted operation instructions; and
causing a user interface to be presented that suggests an adjustment in the operation of the device using the operation instructions.

7. A system for energy management in buildings, the system comprising:
a hardware processor that is configured to:
identify a plurality of devices associated with a building;
generate a standardized identifier for each of the plurality of devices, wherein the standardized identifier includes location information, a device type, and an index number;
receive weather data and energy pricing information;
receive, from the plurality of devices, a stream of building data, wherein each piece of building data has a data type and is associated with the standardized identifier for that device;
determine whether operation of one or more of the plurality devices is to be modified based on the weather data, the energy pricing information, and the stream of building data;
in response to determining that the operation of a device is to be modified based on the weather data, the energy pricing information, and the stream of building data, determine operating instructions based on the device type and the location information from the standardized identifier of the device; and
transmit the operating instructions to the device associated with the building.

8. The system of claim 7, wherein the plurality of devices includes one or more of: a lighting sensor, a solar radiation sensor, an occupancy sensor, a temperature sensor, an air quality sensor, a smoke detector, a ventilation system, a heating system, a cooling system, an access control system, a media device, a thermostat device, a window shade device, an electrochromic glass device, a lighting system, a home appliance, and a smart power outlet.

9. The system of claim 7, wherein the hardware processor is further configured to:
determine a user-selected energy usage criterion; and
based on the user-selected energy usage criterion, cause a user interface to be presented on a computing device that requests a user initiate the modification of the operation of the device with the determined operating instructions.

10. The system of claim 7, wherein the modification of the operation of the device is determined using an optimizer that receives the weather data, the energy pricing information, and the stream of building data as input.

11. The system of claim 7, wherein a second portion of building data is derived from a first portion building data in the stream of building data.

12. The system of claim 7, wherein the hardware processor is further configured to:
determine that the device associated with the building is not capable of being controlled via the transmitted operation instructions; and
cause a user interface to be presented that suggests an adjustment in the operation of the device using the operation instructions.

13. A non-transitory computer-readable medium containing computer executable instructions that, when executed by a processor, cause the processor to perform a method for energy management in buildings, the method comprising:
identifying a plurality of devices associated with a building;
generating a standardized identifier for each of the plurality of devices, wherein the standardized identifier includes location information, a device type, and an index number;
receiving weather data and energy pricing information;
receiving, from the plurality of devices, a stream of building data, wherein each piece of building data has a data type and is associated with the standardized identifier for that device;
determining whether operation of one or more of the plurality devices is to be modified based on the weather data, the energy pricing information, and the stream of building data;
in response to determining that the operation of a device is to be modified based on the weather data, the energy pricing information, and the stream of building data, determining operating instructions based on the device type and the location information from the standardized identifier of the device; and
transmitting the operating instructions to the device associated with the building.

14. The non-transitory computer-readable medium of claim 13, wherein the plurality of devices includes one or more of: a lighting sensor, a solar radiation sensor, an occupancy sensor, a temperature sensor, an air quality sensor, a smoke detector, a ventilation system, a heating system, a cooling system, an access control system, a media device, a thermostat device, a window shade device, an electrochromic glass device, a lighting system, a home appliance, and a smart power outlet.

15. The non-transitory computer-readable medium of claim 13, wherein the method further comprises:
determining a user-selected energy usage criterion; and
based on the user-selected energy usage criterion, causing a user interface to be presented on a computing device that requests a user initiate the modification of the operation of the device with the determined operating instructions.

16. The non-transitory computer-readable medium of claim 13, wherein the modification of the operation of the device is determined using an optimizer that receives the weather data, the energy pricing information, and the stream of building data as input.

17. The non-transitory computer-readable medium of claim 13, wherein a second portion of building data is derived from a first portion building data in the stream of building data.

18. The non-transitory computer-readable medium of claim 1, wherein the method further comprises:
determining that the device associated with the building is not capable of being controlled via the transmitted operation instructions; and
causing a user interface to be presented that suggests an adjustment in the operation of the device using the operation instructions.
